(19) United States
(12) Patent Application Publication
(10) Pub. No.: US 2019/0037424 A1
(43) Pub. Date: Jan. 31, 2019

(54) MOBILE TERMINAL TESTING APPARATUS AND PARAMETER CHANGING METHOD THEREFOR

(71) Applicant: ANRITSU CORPORATION, Kanagawa (JP)

(72) Inventor: Keita SHIRASAKI, Kanagawa (JP)

(21) Appl. No.: 16/045,845

(22) Filed: Jul. 26, 2018

(30) Foreign Application Priority Data
Jul. 27, 2017 (JP) 2017-145139

(51) Int. Cl. H04W 24/06; H04L 5/00

(52) U.S. Cl. CPC H04W 24/06; H04L 5/001

(57) ABSTRACT

To provide a mobile terminal testing apparatus capable of facilitating a change or rearrangement of a pseudo base station performing carrier aggregation and efficiently performing a test of the carrier aggregation. The mobile terminal testing apparatus includes an operation unit 11 that receives an operation input from a user, a display unit 12 that displays an image, and a control unit 14 that causes the display unit 12 to display an identification name of a pseudo base station of carrier aggregation of a scenario that has already been created, causes the identification name of the pseudo base station to be changed by an operation of the operation unit 11, and causes a scenario to be created on the basis of a configuration of the changed pseudo base station.

### TECHNICAL FIELD

The present invention relates to a mobile terminal testing apparatus that performs a test on a mobile communication terminal.

### BACKGROUND ART

When a mobile communication terminal such as a mobile phone or a data communication terminal has been developed, it is necessary to test whether or not the developed mobile communication terminal can normally perform communication. Therefore, a mobile communication terminal that is a test target is connected to a testing apparatus that operates as a pseudo base station that simulates a function of an actual base station, communication is performed between the testing apparatus and the mobile communication terminal, and a test for confirming content of the communication is performed.

Further, in 3rd Generation Partnership Project (3GPP) in which a standard for wireless communication is created, a carrier aggregation technology is introduced under a LongTerm Evolution-Advanced (LTE-A) standard. This carrier aggregation is intended to improve a transmission speed by performing communication using a plurality of LTE carriers simultaneously.

In the carrier aggregation, communication is performed using a plurality of LTE carriers called component carriers (hereinafter also referred to as CCs). In the carrier aggregation, communication is performed using one primary component carrier (hereinafter also referred to as a “PCC”) which is a CC required for the mobile communication terminal to maintain a connection with a base station and one or more secondary component carriers (hereinafter also referred to as SCCs) which are CCs that are used to improve a transmission speed between the mobile communication terminal and the base station.

Patent Document 1 describes a testing apparatus that can perform a test of carrier aggregation.

### RELATED ART DOCUMENT

### Patent Document

[Patent Document 1] US 2014/0029440 A1

### DISCLOSURE OF THE INVENTION

### Problem that the Invention is to Solve

When a test of carrier aggregation is performed, parameters for performing communication of a PCC or a SCC are set for each pseudo base station, the PCC or the SCC is simulated, and the test is performed.

However, when a test is performed by changing allocation of the PCC or the SCC to the pseudo base station or a combination of pseudo base stations performing carrier aggregation, it is necessary to set the same parameters as another pseudo base station, and it takes a long time to perform the test.

Therefore, an object of the present invention is to provide a mobile terminal testing apparatus capable of facilitating a change or rearrangement of a pseudo base station performing carrier aggregation and efficiently performing a test of the carrier aggregation.

### Means for Solving the Problem

A mobile terminal testing apparatus of the present invention is a mobile terminal testing apparatus that constitutes carrier aggregation on the basis of a plurality of parameters set for each of a plurality of component carriers and performs a test of a mobile communication terminal using the constituted carrier aggregation, the mobile terminal testing apparatus including: a control unit that exchanges, among the plurality of component carriers, some of the parameters preset in the component carriers.

With this configuration, some parameters are exchanged among the component carriers, with the setting of the parameters of existing carrier aggregation maintained as it is. Therefore, it is not necessary to perform the setting of the parameters again, and it is possible to efficiently perform a test of the carrier aggregation.

Further, the mobile terminal testing apparatus of the present invention includes an operation unit that receives an operation input from a user; and a display unit that displays an image, wherein the control unit displays information for identifying the component carriers constituting the current carrier aggregation on the display unit, changes the information for identifying the component carriers on the basis of an operation of the operation unit to rearrange the component carriers constituting the carrier aggregation, and exchanges, among the component carriers, some of the parameters preset in the component carriers on the basis of the rearranged constitution.

With this configuration, the information for identifying the component carrier displayed on the display unit is rearranged, and accordingly, some parameters are exchanged among the component carriers. Therefore, it is possible to easily designate rearrangement of component carriers, and it is possible to efficiently perform a test of the carrier aggregation.

Further, in the mobile terminal testing apparatus of the present invention, it is preferable for some of the parameters preset in the component carriers to include at least a cell ID, a frequency, and a frequency bandwidth.

Further, a parameter change method of the present invention is a parameter changing method of a mobile terminal testing apparatus that constitutes carrier aggregation on the basis of parameters set for each of a plurality of component carriers and performs a test of a mobile communication terminal using the constituted carrier aggregation, the parameter changing method including: a step of reading the parameters set in the component carrier constituting a current carrier aggregation; a step of rearranging the component carriers constituting the current carrier aggregation; and a step of exchanging, among the component carriers, some of the parameters preset in the component carriers on the basis of the rearranged constitution.

Further, in the parameter changing method of the present invention, the step of rearranging the component carriers constituting the current carrier aggregation includes: a step of displaying information for identifying the component carriers constituting the current carrier aggregation on a display unit; and a step of changing the information for identifying the component carriers on the basis of an operation of an operation unit to rearrange the component carriers constituting the carrier aggregation.

Further, in the parameter changing method of the present invention, it is preferable for some of the parameters preset in the component carriers to include at least a cell ID, a frequency, and a frequency bandwidth.

With this configuration, some parameters are exchanged among the component carriers, with the setting of the parameters of existing carrier aggregation maintained as it is. Therefore, it is not necessary to perform the setting of the parameters again, and it is possible to efficiently perform a test of the carrier aggregation. [Advantage of the Invention]

The present invention can provide a mobile terminal testing apparatus capable of efficiently performing a test of carrier aggregation.

### BRIEF DESCRIPTION OF THE DRAWINGS

FIG. 1 is a block diagram of a mobile terminal testing apparatus according to an embodiment of the present invention.

FIG. 2 is a diagram illustrating an example of setting content of carrier aggregation of an existing scenario of the mobile terminal testing apparatus according to the embodiment of the present invention.

FIG. 3 is a diagram illustrating an example of a cell state of the carrier aggregation in the existing scenario of the mobile terminal testing apparatus according to the embodiment of the present invention.

FIG. 4 is a diagram illustrating an example of setting content of the carrier aggregation in which a pseudo base station in the existing scenario of the mobile terminal testing apparatus according to an embodiment of the present invention is rearranged.

FIG. 5 is a diagram illustrating an example of a cell state of carrier aggregation in which a pseudo base station in the existing scenario of the mobile terminal testing apparatus according to an embodiment of the present invention is rearranged.

FIG. 6 is a flowchart illustrating a procedure of a scenario conversion process of a mobile terminal testing apparatus according to an embodiment of the present invention.

### BEST MODE FOR CARRYING OUT THE INVENTION

Hereinafter, a mobile terminal testing apparatus according to an embodiment of the present invention will be described in detail with reference to the drawings.

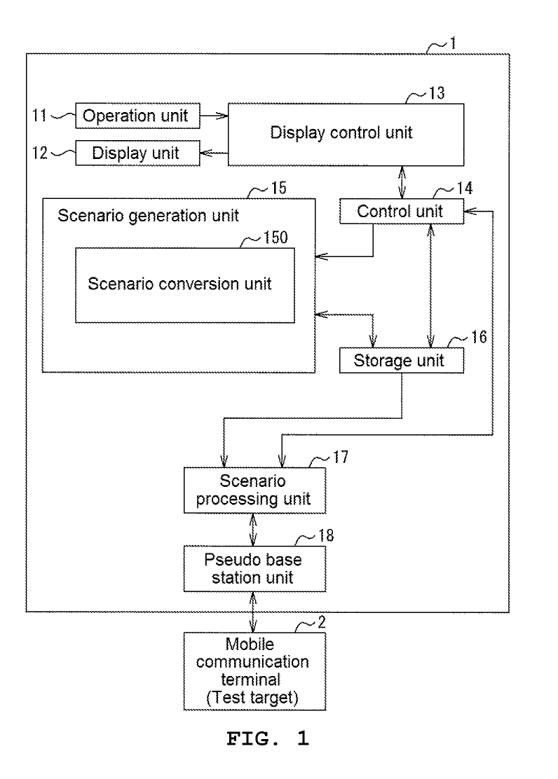

In FIG. 1, a mobile terminal testing apparatus 1 according to an embodiment of the present invention transmits or receives a radio signal to and from a mobile communication terminal 2 via a coaxial cable or the like as a pseudo base station.

The mobile terminal testing apparatus 1 includes an operation unit 11, a display unit 12, a display control unit 13, a control unit 14, a scenario generation unit 15, a storage unit 16, a scenario processing unit 17, a pseudo base station unit 18.

The operation unit 11 includes input devices such as a keyboard, a mouse, and a touch panel, and outputs, for example, information necessary for generation of a scenario input through an operation to the display control unit 13. The display unit 12 includes an image display device such as a liquid crystal display and displays an image for inputting information necessary for generation of a scenario, an image indicating a state during test, and the like.

The display control unit 13 generates and displays an image to be displayed on the display unit 12, and is configured to perform control of generation and display of an image according to an instruction from the control unit 14. Further, the display control unit 13 changes the display on the display unit 12 on the basis of information input to the operation unit 11 or transmits the information input to the operation unit 11 to the control unit 14.

The control unit 14 causes the display control unit 13 to display a scenario creation screen on the display unit 12 according to an instruction input to the operation unit 11 to cause information necessary for generation of a scenario to be input, or transmits information input to the operation unit 11 on the scenario creation screen to the scenario generation unit 15 to cause the scenario to be generated. Further, the control unit 14 transmits an instruction to the scenario processing unit 17 according to an instruction input to the operation unit 11 to cause the test to be executed on the basis of the scenario stored in the storage unit 16, or causes the display control unit 13 to display, for example, a state during test on the display unit 12 on the basis of information such as a state of the pseudo base station unit 18, a state of communication with the mobile communication terminal 2 transmitted from the scenario processing unit 17.

The scenario generation unit 15 generates a scenario for testing the mobile communication terminal 2 on the basis of the information for scenario generation transmitted from the control unit 14. An operation of the pseudo base station unit 18 or a communication sequence with the mobile communication terminal 2 is set in this scenario. The scenario generation unit 15 includes a scenario conversion unit 150 that generates transmission information to be transmitted from the pseudo base station unit 18 on the basis of the information for scenario generation.

The storage unit 16 includes a hard disk device or a flash memory, and stores various scenarios generated by the scenario generation unit 15.

The scenario processing unit 17 reads the scenario stored in the storage unit 16 according to an instruction from the control unit 14 and transmits the notification information to the pseudo base station unit 18 on the basis of the scenario or executes a communication sequence with the mobile communication terminal 2.

The pseudo base station unit 18 transmits and receives a radio signal to and from the mobile communication terminal according to an instruction from the scenario processing unit 17. The pseudo base station unit 18 can simulate a plurality of base stations. The pseudo base station unit 18 combines signals of the plurality of pseudo base stations and transmits a resultant signal to the mobile communication terminal 2. The pseudo base station unit 18 processes the signal received from the mobile communication terminal 2, in a plurality of pseudo base stations.

Here, the mobile terminal testing apparatus 1 is configured of a computer device (not illustrated) provided with a communication module for performing communication with the mobile communication terminal 2. This computer device includes a central processing unit (CPU), a read only memory (ROM), a random access memory (RAM), a hard disk device, an input and output port, and a touch panel (not illustrated).

A program for causing the computer device to function as the mobile terminal testing apparatus 1 is stored in the ROM and the hard disk device of this computer device. That is, the computer device functions as the mobile terminal testing apparatus 1 by the CPU executing the program stored in the ROM using the RAM as a work area.

Thus, in this embodiment, the storage unit 16 is configured of a RAM or a hard disk device, the display control unit 13, the control unit 14, the scenario generation unit 15, and the scenario processing unit 17 are configured of a CPU, and the pseudo base station unit 18 is configured of a communication module.

In the mobile terminal testing apparatus 1 having such a configuration, when test of the mobile communication terminal 2 is performed, creation of a scenario to be used for test is first performed by the user. When a scenario creation function is selected according to an operation of the operation unit 11 by the user, for example, the control unit 14 causes the display unit 12 to display a scenario creation screen and causes, for example, a parameter such as the CC of a base station simulated by the pseudo base station unit 18 to be set.

The CC parameters include a cell ID, a frequency, a frequency bandwidth, downlink/uplink resource information and schedule information, modulation and coding scheme (MCS), a resource block (RB) number, RB start, the number of RBs, and the like.

The “Cell ID” is identification information for identifying a base station. The “MCS” is information on a modulation scheme and a coding scheme. The “RB start” indicates an allocation start position of the RB. The “number of RB” indicates the number of allocated RBs from the RB start.

When a setting of the carrier aggregation is selected by an operation of the operation unit 11 by the user, the control unit 14, for example, causes the display unit 12 to display a carrier aggregation setting screen and causes a configuration of the PCC or the SCC of the carrier aggregation to be set.

The control unit 14 causes, for example, the number of PCCs to be input as the number of carrier aggregations. The control unit 14 causes the number of CCs of the carrier aggregation to be input. The control unit 14 causes a pseudo base station simulating the PCC or the SCC to be input as a configuration of carrier aggregation. Here, the pseudo base station is a pseudo base station in which the above parameters of the CC are set and is identified by an identification name such as BTS1, BTS2, or BTS3 in the embodiment.

The control unit 14 transmits information on the parameters of the CC and the configuration of the carrier aggregation set in this way to the scenario generation unit 15.

The scenario generation unit 15 generates a scenario according to which the pseudo base station unit 18 simulates the base station on the basis of the received information.

The scenario generation unit 15 stores the scenario of the pseudo base station generated in this way in the storage unit 16 so that the scenario can be identified by the identification information input by the user, for example.

The scenario stored in this way is read and used at the time of the test. When a setting of the scenario is selected by the user operating the operation unit 11, the control unit 14 reads, for example, the identification information of the scenario of the pseudo base station stored in the storage unit 16, and causes the display unit 12 to display a list of identification information and a message for performing selection of the scenario to be set.

When the scenario of the pseudo base station is selected by the user operating the operation unit 11, the control unit 14 transmits the identification information of the selected scenario of the pseudo base station to the scenario processing unit 17.

When the scenario processing unit 17 receives the identification information of the scenario of the pseudo base station from the control unit 14, the scenario processing unit 17 reads the scenario of the pseudo base station corresponding to the identification information from the storage unit 16, performs a setting of the pseudo base station unit 18 according to the scenario, and causes the pseudo base station unit 18 to perform a process of the pseudo base station.

When the scenario is set and the process of the pseudo base station unit 18 is started, the mobile communication terminal 2 connected to the mobile terminal testing apparatus by a wire, for example, is powered on, position registration is performed, the mobile communication terminal 2 is operated, and a test is performed. It should be noted that the mobile terminal testing apparatus 1 and the mobile communication terminal 2 may be wirelessly connected.

The mobile terminal testing apparatus 1 of the embodiment can easily rearrange the pseudo base stations of the carrier aggregation of scenarios that have already been created and stored in the storage unit 16.

In the mobile terminal testing apparatus 1 of the embodiment, in the setting of the carrier aggregation of the scenario that has been already created, the setting of the carrier aggregation of downlink/uplink resource information and schedule information, the MCS, and the number of RBs is maintained as it is, and the setting of the base station such as the cell ID, the frequency, and the frequency bandwidth is exchanged such that the rearrangement of the pseudo base stations can be performed.

When the base station rearrangement of the carrier aggregation is selected by the user operating the operation unit 11, the control unit 14 reads, for example, the identification information of the scenarios in which the carrier aggregation is set among the scenarios of the pseudo base stations stored in the storage unit 16, causes the display unit 12 to display the scenarios as a list, and causes the display unit 12 to display a message for causing a scenario for rearranging the pseudo base stations to be selected.

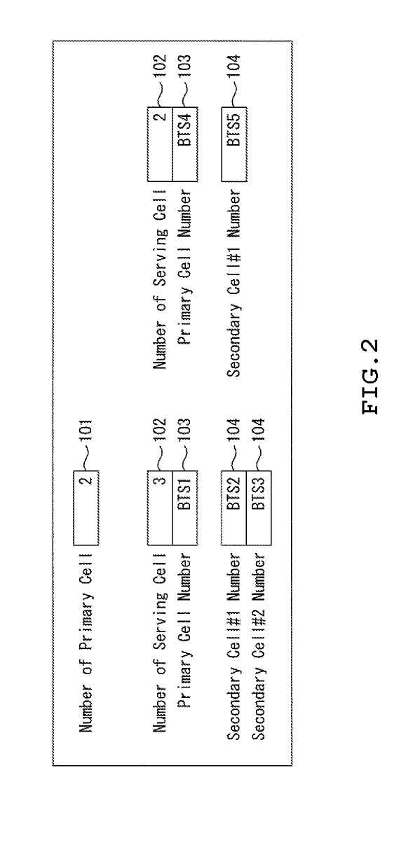

When the scenario of the pseudo base station is selected by the user operating the operation unit 11, the control unit 14 causes the display unit 12 to display the screen as illustrated in FIG. 2 according to the setting content of the scenario.

In FIG. 2, values set in the selected scenario are displayed in a number-of-primary-cells display portion 101 and a number-of-cells display portion 102 so that the values cannot be changed.

The number of pseudo base stations that are PCCs as the number of carrier aggregations is displayed in the number-of-primary-cells display portion 101.

The number of CCs that perform the carrier aggregation is displayed in the number-of-cells display portion 102. The number-of-cells display portion 102 is displayed by the number corresponding to the number of carrier aggregations displayed in the number-of-primary-cells display portion 101.

In FIG. 2, the values set in the selected scenario are displayed in the primary cell display setting portion 103 and the secondary cell display setting portion 104 and can be changed. It is possible to rearrange the pseudo base stations by changing content of the primary cell display setting portion 103 and the secondary cell display setting portion 104.

The primary cell display setting portion 103 and the secondary cell display setting portion 104 are displayed for each number-of-cells display portion 102, and the secondary cell display setting portion 104 is displayed by the number corresponding to the value of the number-of-cells display portion 102.

The identification name of the pseudo base station that performs a process of the PCC is displayed in the primary cell display setting portion 103. The identification name of the pseudo base station that performs a process of the SCC is displayed in the secondary cell display setting portion 104.

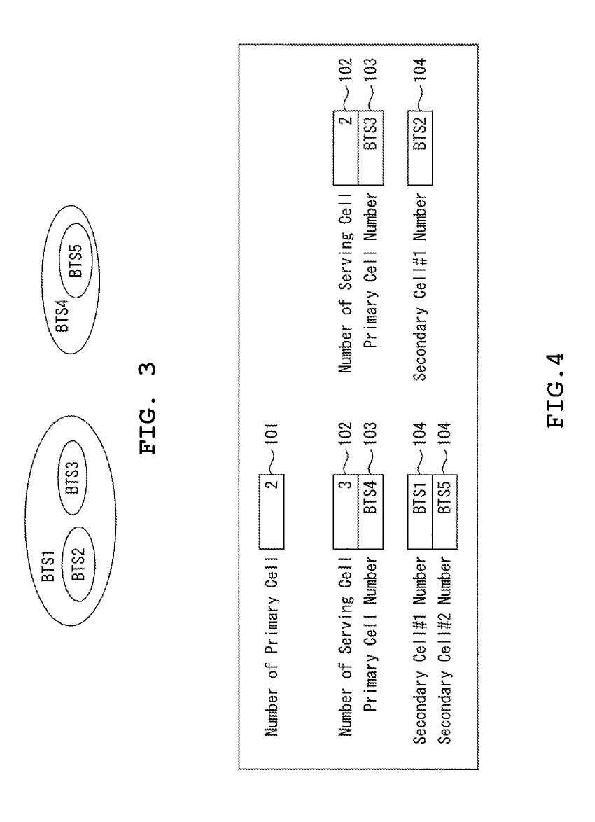

In a setting state of FIG. 2, carrier aggregation with BTS 1 as the PCC and carrier aggregation with BTS4 as the PCC are set, as illustrated in FIG. 3. BTS2 and BTS3 are set as the SCC in the carrier aggregation with BTS 1 as the PCC. BTS5 is set as the SCC in the carrier aggregation with BTS4 as the PCC.

In such a setting of the carrier aggregation, it is possible to maintain the setting of the carrier aggregation as it is and exchange the setting of the base station associated with the identification name of the pseudo base station by changing the identification name of the pseudo base station of the primary cell display setting portion 103 and the secondary cell display setting portion 104.

The control unit 14 causes the primary cell display setting portion 103 and the secondary cell display setting portion 104 to display a list of identification names of the pseudo base stations set in the selected scenario as a pull-down list, and causes the pseudo base station to be selected.

When the end of setting is selected by the user operating the operation unit 11, the control unit 14 confirms, for example, whether there is no duplication in the identification names of the pseudo base station set in the primary cell display setting portion 103 and the secondary cell display setting portion 104, and transmits information on setting content to the scenario generation unit 15 when there is no problem in the setting content.

The scenario generation unit 15 causes the scenario conversion unit 150 to execute the conversion of the selected scenario on the basis of the received information to convert information for generating the scenario. The scenario generation unit 15 generates a scenario according to which the pseudo base station unit 18 simulates the base station on the basis of converted information.

The scenario generation unit 15 stores the scenario of the pseudo base station generated in this way in the storage unit 16 so that the scenario can be identified by the identification information input by the user, for example.

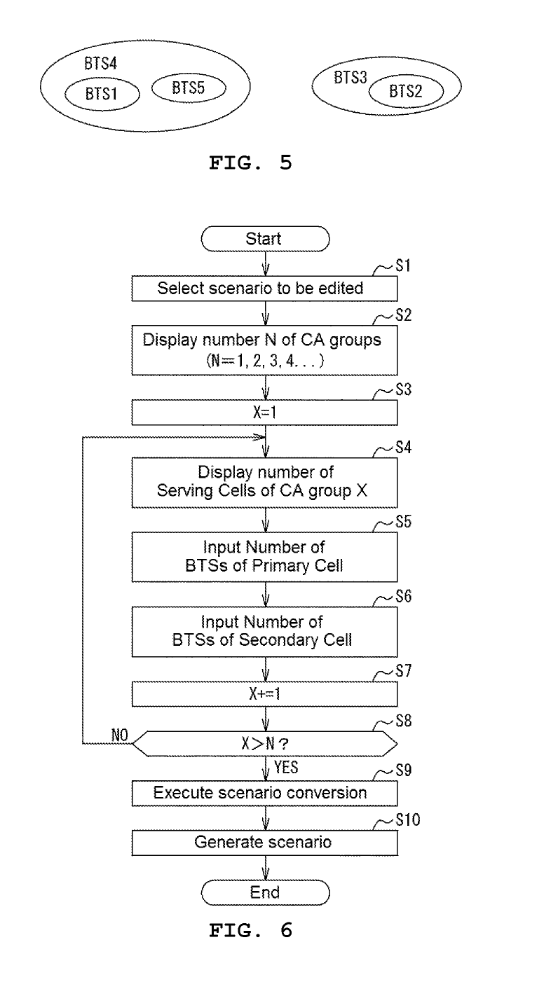

For example, as illustrated in FIG. 4, the PCC of the carrier aggregation of three cells is changed to BTS 4 and the SCC is changed to BTS1 and BTS 5, and the PCC of the carrier aggregation of two cells is changed to BTS 3 and SCC is changed to BTS 2. In this case, a scenario of the pseudo base station in which the setting of the downlink/uplink resource information and schedule information, the MCS, and the number of RBs of the carrier aggregation is maintained as it is, and the setting of the cell ID, the frequency, and the frequency bandwidth of the base station associated with the identification name of the pseudo base station has been changed is generated as illustrated in FIG. 5.

In the related art, even when the setting of the base station is changed with the setting of the carrier aggregation maintained as it is, all settings have to be newly performed again. In the mobile terminal testing apparatus 1 of the embodiment, it is possible to generate the scenario only by changing the identification name of the pseudo base station, and to efficiently perform the test of the carrier aggregation.

A scenario conversion process of the mobile terminal testing apparatus 1 according to this embodiment configured as described above will be described with reference to FIG. 6. It should be noted that the scenario conversion process to be described below is executed when base station rearrangement of the carrier aggregation is selected.

In step S1, the control unit 14 causes the scenario to be edited to be selected from the scenarios of the pseudo base station in which the carrier aggregation stored in the storage unit 16 is set.

In step S2, the control unit 14 causes the display unit 12 to display the number N of groups of carrier aggregations set from the selected scenario. This corresponds to a value displayed in the number-of-primary-cells display portion 101 described above.

In step S3, the control unit 14 substitutes 1 for X. In step S4, the control unit 14 causes the display unit 12 to display the number of serving cells of a group X of the carrier aggregations from the selected scenario. This corresponds to the value displayed on the number-of-cells display portion 102.

In step S5, the control unit 14 causes the identification name of the pseudo base station of the primary cell to be input. This corresponds to the value displayed on the primary cell display setting portion 103.

In step S6, the control unit 14 causes the identification name of the pseudo base station of the secondary cell to be input. This corresponds to the value displayed on the secondary cell display setting portion 104 described above.

In step S7, the control unit 14 adds 1 to X. In step S8, the control unit 14 determines whether or not X is greater than N. When the control unit 14 determines that X is not greater than N, the control unit 14 causes the process to return to step S4 and repeats the process.

When the control unit 14 determines in step S8 that X is greater than N, the control unit 14 transmits input information to the scenario generation unit 15 to cause a scenario to be generated.

In step S9, the scenario generation unit 15 causes the scenario conversion unit 150 to execute the conversion of the scenario based on the information received from the control unit 14.

In step S10, the scenario generation unit 15 generates a scenario on the basis of the information converted by the scenario conversion unit 150, stores the scenario in the storage unit 16, and ends the process.

Thus, in the above-described embodiment, the control unit 14 that maintains the setting of the carrier aggregation of downlink/uplink resource information and the schedule information, the MCS, the number of RBs, and the like as it is, in the setting of the carrier aggregation of the scenario that has been already created, and exchanges the setting of the cell ID, the frequency, and the frequency bandwidth of the base station associated with the identification name of the pseudo base station is included.

Accordingly, it is possible to exchange the setting of the base station with the setting of the carrier aggregation of the existing scenario maintained as it is, and to efficiently perform the test of the carrier aggregation.

Further, the control unit 14 causes the display unit 12 to display the setting content of the existing scenario of the pseudo base station by the user operating the operation unit 11 and changes the identification name of the pseudo base station to thereby exchange the setting of the base station.

Thus, it is possible to exchange the setting of the base station by changing the identification name of the pseudo base station displayed on the display unit 12, and to efficiently perform the test of the carrier aggregation.

It should be noted that, in the present embodiment, the cell ID, the frequency, the frequency bandwidth, and the like are used as the parameters of the base station, but the present invention is not limited thereto, and other parameters may be added or the parameters may be excluded.

Although the embodiment of the present invention has been disclosed, it will be apparent to those skilled in the art that changes may be made without departing from the scope of the invention. All of such modifications and equivalents are intended to be included in the following claims.

### DESCRIPTION OF REFERENCE NUMERALS AND SIGNS

1: mobile terminal testing apparatus
2: mobile communication terminal
11: operation unit
12: display unit
14: control unit
15: scenario generation unit
16: storage unit
101: number-of-primary-cells display portion
102: number-of-cells display portion
103: primary cell display setting portion
104: secondary cell display setting portion
150: scenario conversion unit

What is claimed is:

1. A mobile terminal testing apparatus that constitutes carrier aggregation on the basis of a plurality of parameters set for each of a plurality of component carriers and performs a test of a mobile communication terminal using the constituted carrier aggregation, the mobile terminal testing apparatus comprising:
a control unit that exchanges, among the plurality of component carriers, some of the parameters preset in the component carriers.

2. The mobile terminal testing apparatus according to claim 1, comprising:
an operation unit that receives an operation input from a user; and
a display unit that displays an image,
wherein the control unit displays information for identifying the component carriers constituting the current carrier aggregation on the display unit, changes the information for identifying the component carriers on the basis of an operation of the operation unit to rearrange the component carriers constituting the carrier aggregation, and exchanges, among the component carriers, some of the parameters preset in the component carriers on the basis of the rearranged constitution.

3. The mobile terminal testing apparatus according to claim 1, wherein some of the parameters preset in the component carriers include at least a cell ID, a frequency, and a frequency bandwidth.

4. A parameter changing method of a mobile terminal testing apparatus that constitutes carrier aggregation on the basis of parameters set for each of a plurality of component carriers and performs a test of a mobile communication terminal using the constituted carrier aggregation, the parameter changing method comprising:
a step of reading the parameters set in the component carrier constituting a current carrier aggregation;
a step of rearranging the component carriers constituting the current carrier aggregation; and
a step of exchanging, among the component carriers, some of the parameters preset in the component carriers on the basis of the rearranged constitution.

5. The parameter changing method according to claim 4, wherein the step of rearranging the component carriers constituting the current carrier aggregation includes:
a step of displaying information for identifying the component carriers constituting the current carrier aggregation on a display unit; and
a step of changing the information for identifying the component carriers on the basis of an operation of an operation unit to rearrange the component carriers constituting the carrier aggregation.

6. The parameter changing method according to claim 4, wherein some of the parameters preset in the component carriers include at least a cell ID, a frequency, and a frequency bandwidth.
